(19) United States
(12) Patent Application Publication
(10) Pub. No.: US 2018/0298248 A1
(43) Pub. Date: Oct. 18, 2018

(54) METHOD FOR MEASURING BIREFRINGENCE TEMPERATURE DEPENDENCE OF ADHESIVE, METHOD FOR DESIGNING AND MANUFACTURING ADHESIVE, ADHESIVE, DISPLAY, AND OPTICAL FILM

(71) Applicants: SAIDEN CHEMICAL INDUSTRY CO., LTD., Tokyo (JP); KEIO UNIVERSITY, Tokyo (JP)

(72) Inventors: Yasuhiro KOIKE, Yokohama-shi, Kanagawa (JP); Akihiro TAGAYA, Yokohama-shi, Kanagawa (JP); Sumihisa ODA, Saitama (JP)

(21) Appl. No.: 15/568,648

(22) PCT Filed: Mar. 16, 2017
(86) PCT No.: PCT/JP2017/010803

§ 371 Date: Oct. 23, 2017

(30) Foreign Application Priority Data
Mar. 22, 2016 (JP) 2016-057624

(51) Int. Cl. C09J 133/12; B32B 7/12; B32B 7/02; C08F 220/14; G01N 21/23

(52) U.S. Cl. CPC C09J 133/12; B32B 7/12; B32B 2307/42; C08F 220/14; G01N 21/23; B32B 7/02

(57) ABSTRACT

The present invention intends to provide a display, or an optical film with an adhesive, in which a bend of the display or peeling of the optical film does not occur even when the display or the optical film is used under an environment where a temperature change is large, and birefringence due to deformation of an adhesive can be suppressed stably irrespective of the temperature change, and occurrence of light leakage and the like is suppressed, so that the optical performance is more excellent, by pasting a glass plate and an optical film together with an adhesive in which temperature dependence of the birefringence is zero. The present invention relates to a technique for obtaining the above-described effects, the technique capable of stably providing an adhesive in which both the birefringence and the temperature dependence of the birefringence are zero, the adhesive having a measured value of birefringence of an adhesive Δn⁰ within a range of ±0.2×10⁻⁴ and having a temperature coefficient of the birefringence of an adhesive dΔn⁰/dT within a range of ±0.02×10⁻⁵/° C. The adhesive is utilized in a display having a structure obtained by pasting a transparent substrate and an optical film together through an adhesive layer, or is utilized in an adhesive layer of an optical film with an adhesive.

### TECHNICAL FIELD

The present invention relates to a display, an optical film, an adhesive, and a method for measuring temperature dependence of birefringence of an adhesive, and a method for designing/producing an adhesive.

### BACKGROUND ART

In a liquid crystal display (LCD), an organic EL display, and the like, an adhesive is used for pasting together a glass plate and an optical film which are members. The spread and growth of these displays are remarkable, and these displays have become widely used for various mobile terminals and automobiles. In these applications, these displays are used under an environment of a low temperature to a high temperature accompanied by a change in the environment such as a season and a place of use. Therefore, the displays are exposed to considerable temperature changes during use.

In addition, a curved surface type display, a flexible display, a foldable display, and the like have been studied recently, and in these cases, a glass plate, an optical film, and an adhesive each being a constituent member are used in a deformed state. Generally, birefringence occurs in these members when deformed. Further, according to studies conducted by the present inventors, the birefringence also changes due to a temperature change in deformed members. The change in birefringence is a cause of affecting products in which enhancement of quality is progressing, and when an environmental change becomes large, a stable and high optical performance as a display cannot be exhibited. Moreover, in a product using the members in a deformed state as described above, the influence of the change in birefringence becomes particularly remarkable.

Against the problem that the displays as described above are exposed to the temperature change during use, the measure as described below has been taken and various studies have also been conducted. The optical film and the glass plate that constitute a display have a different thermal expansion coefficient. Therefore, in a display having a structure in which the optical film and the glass plate are pasted together with an adhesive, a difference between expansion rates occurs when the temperature changes, and the difference becomes a cause for a bend of the display and peeling of the optical film. Against the problem, the adhesive used for pasting the optical film and the glass plate together has plasticity and therefore is designed to deal with the bend and the peeling by being deformed so that the bend and the peeling will not occur. However, when the adhesive is deformed, the birefringence occurs therein. The present inventors have made diligent studies to develop a zero-birefringence adhesive in which the birefringence does not occur even when the adhesive is deformed to find a method for evaluating birefringence properties of an adhesive as part of the development and, using this method, have proposed a method for designing an adhesive useful for obtaining the zero-birefringence adhesive (see Patent Literature 1).

In the evaluation method described in Patent Literature 1, polymer films each having an intrinsic birefringence of 1×10⁻³ or less as the absolute value and each having a photoelastic constant of 1×10⁻¹² Pa⁻¹ or less as the absolute value, namely zero-zero-birefringence polymer (ZZBP) films in which the birefringence does not occur even when the film is stretched and deformed, are utilized as supports, and a composite (laminated) film obtained by sandwiching the adhesive between two sheets of the polymer films is stretched to measure the birefringence, so that the birefringence of the adhesive can be measured. Further, the birefringence of an adhesive can be measured with this technique, and thereby the zero-birefringence adhesive is designed.

On the other hand, there is proposed a method for surely designing an optical resin which has very small orientation birefringence and photoelastic birefringence and which can also be used as the zero-zero-birefringence polymer film which is essential in the above-described evaluation method (see Patent Literature 2). According to the technique described in patent Literature 2, both the orientation birefringence property and the photoelastic birefringence property of an optical resin material can be lessened and almost eliminated, and further, by using such an optical resin material in which the orientation birefringence property and the photoelastic birefringence property are almost eliminated, an optical member, such as an optical film, can be provided which hardly exhibits the orientation birefringence even when a process, such as extrusion molding, stretch molding, or injection molding, in which orientation of a polymer main chain occurs is included in the production process and which hardly exhibits the photoelastic birefringence even when the optical member is subjected to elastic deformation due to external force or the like.

### CITATION LIST

### Patent Literature

Patent Literature 1: International Publication No. WO 2011142325

Patent Literature 2: Japanese Patent No. 4624845

### SUMMARY OF INVENTION

### Technical Problem

In the conventional techniques described above, the present inventors have recognized the new problem described below and have recognized the necessity to conduct further studies. That is, as described above, in the zero-birefringence adhesive designed by the method described in Patent Literature 1, the birefringence is zero when the birefringence is determined by measuring at room temperature (25° C.) the composite (laminated) film which is obtained by sandwiching the adhesive between two sheets of the polymer films and which is stretched thereafter, and a study on how the birefringence of the adhesive changes when the temperature of the adhesive changes has not been conducted. In such a situation, it is inevitable in practical use that the temperature change will occur in the adhesive used for a display placed in various environments, which is an important issue. The present inventors have recognized that a major reason that such an important issue has not been studied is that a method for accurately measuring the temperature dependence of the birefringence of an adhesive has not existed in the conventional techniques. Specifically, when the birefringence of a stretched zero-zero-birefringence polymer (ZZBP) film is measured at a high temperature (for example, 60° C.), the birefringence is not zero, wherein the zero-zero-birefringence polymer (ZZBP) film is used for the measurement of the birefringence of an adhesive in the technique described in Patent Literature 1, and the birefringence does not occur at room temperature (25° C.) even when the film is stretched and deformed, and therefore the birefringence of an adhesive at a high temperature has not been able to be measured by this method.

In such a situation, the present inventors have thought that when an optical film being a resin having a very small orientation birefringence in the case where the resin is stretched and deformed, the optical film having a reduced temperature dependence of the intrinsic birefringence obtained by taking into consideration the temperature dependence of the intrinsic birefringence that affects the optical properties can be obtained, the birefringence of an adhesive can be measured with the technique described in Patent Literature 1 while dealing with the temperature dependence. However, the optical properties in the optical resin which is obtained in Patent Literature 2, which is useful as the optical film or the like, and which has very small orientation birefringence and photoelastic birefringence are properties at room temperature and have not been able to be utilized as they are.

Accordingly, an object of the present invention is to provide an excellent display in which the bend of the display and the peeling of the optical film do not occur and the lowering of the optical performance due to the birefringence does not occur even when the display is used under an environment where the temperature change is large

by pasting the glass plate and the optical film together, particularly by pasting an optical film in which the temperature dependence of birefringence is zero with an adhesive in which the temperature dependence of birefringence is zero. Further, another object of the present invention is to make it possible to provide an optically high-quality, excellent display which realizes that the birefringence does not occur in various forms of displays, such as a curved surface type display, a flexible display, and a foldable display, which are used in a state where the glass plate, the optical film, and the adhesive each being a constituent member of the displays are used in a deformed state, and the birefringence does not occur even if a deformed member is further subjected to a temperature change. Still another object of the present invention is to develop a temperature-dependence-zero polymer film in which the birefringence is zero (referred to as “temperature-dependence-zero-birefringence polymer) even when the birefringence is measured changing the temperatures as a technique to be a prerequisite for achieving the objects of the present invention described above, and further, to provide a technique with which an adhesive not having the temperature dependence of birefringence can be designed/produced by evaluating an adhesive using the developed temperature-dependence-zero-birefringence polymer.

### Solution to Problem

The objects described above are achieved by the present invention below. That is, the present invention provides a display comprising a structure obtained by pasting a transparent substrate and an optical film together through an adhesive layer, wherein the adhesive layer is formed by an adhesive in which both the birefringence and the temperature dependence of the birefringence are zero, the adhesive having a measured value of birefringence of an adhesive Δn⁰ within a range of ±0.2×10⁻⁴ and having a temperature coefficient of the birefringence of an adhesive dΔn⁰/dT within a range of ±0.02×10⁻⁵/° C., wherein the birefringence of an adhesive Δn⁰ and the temperature coefficient of the birefringence of an adhesive dΔn⁰/dT are measured by a method for measuring the birefringence of an adhesive and a method for measuring the temperature dependence of the birefringence of an adhesive.

Moreover, the present invention provides as another embodiment an optical film with an adhesive, the optical film comprising an adhesive layer formed at least one surface of the optical film, wherein the adhesive layer is formed with an adhesive in which both the birefringence and the temperature dependence of the birefringence are zero, the adhesive having a measured value of birefringence of an adhesive Δn⁰ within a range of ±0.2×10⁻⁴ and having a temperature coefficient of the birefringence of an adhesive dΔn⁰/dT within a range of ±0.02×10⁻⁵/° C., wherein the birefringence of an adhesive Δn⁰ and the temperature coefficient of the birefringence of an adhesive dΔn⁰/dT are measured by a method for measuring the birefringence of an adhesive and a method for measuring the temperature dependence of the birefringence of an adhesive.

Further, the present invention provides as still another embodiment an adhesive in which both the birefringence and the temperature dependence of the birefringence are zero, the adhesive having a measured value of birefringence of an adhesive Δn⁰ within a range of ±0.2×10⁻⁴ and having a temperature coefficient of the birefringence of an adhesive dΔn⁰/dT within a range of ±0.02×10⁻⁵/° C., wherein the birefringence of an adhesive Δn⁰ and the temperature coefficient of the birefringence of an adhesive dΔn⁰/dT are measured by a method for measuring the birefringence of an adhesive and a method for measuring the temperature dependence of the birefringence of an adhesive. As described above, the present invention has a technical feature in that the adhesive layer is formed with the adhesive in which both the birefringence and the temperature dependence of the birefringence are zero, and in the present invention, a numerical value range that can be set as “zero” is specified concretely.

Furthermore, the present invention provides as still yet another embodiment a method for measuring the temperature dependence of birefringence of an adhesive for making it possible to form the special adhesive layer described above. That is, the present invention provides a method for measuring temperature dependence of birefringence of an adhesive, the method as one feature comprising: a step of preparing a laminated film in which polymer films are used as supports, and an adhesive is given between two sheets of the supports to form an adhesive layer; a step of hot-stretching the laminated film; a step of measuring retardation of the laminated film after the hot-stretching; and a step of measuring a thickness of the adhesive layer, wherein: birefringence of an adhesive for the adhesive is defined as a value obtained by dividing the retardation by the thickness; further, in the step of measuring the retardation, a temperature of the laminated film is controlled stepwise in a range of 15 to 70° C. to measure the retardation at each temperature, and from the obtained measurement results, a temperature coefficient of the birefringence of an adhesive dΔn⁰/dT is determined as an amount of change in the birefringence of an adhesive per 1° C. to quantify the temperature dependence of a birefringence value for the adhesive; and the polymer films to be used as the supports for the adhesive, when uniaxially stretched, each have an intrinsic birefringence within a range of ±0.05×10⁻⁴, and the polymer films each have a temperature coefficient of the intrinsic birefringence dΔn⁰/dT within a range of ±0.005×10⁻⁵ between 25° C. to 60° C., the temperature coefficient determined as an amount of change in the intrinsic birefringence per 1° C. from measurement results obtained in such a way that the uniaxially stretched film is used, a temperature of the film is controlled stepwise in a range of 25° C. to 60° C. to measure the intrinsic birefringence Δn⁰ at each temperature.

Examples of the preferred embodiment of the method for measuring the temperature dependence of the birefringence of an adhesive include the method wherein a value of the birefringence of an adhesive at any temperature within a range of 15 to 70° C. for the adhesive is defined as a value obtained by dividing retardation measured with a birefringence measuring apparatus for a sample stretched to 2 times by the thickness of the adhesive layer, wherein the sample is prepared in such a way that the laminated film is cut into a dumbbell shape to make the sample, and the sample is mounted on a tensile testing machine with a thermostatic chamber, heated at a temperature of 102° C. for 120 seconds, thereafter stretched at a tension speed of 40 mm/min until a marked line becomes 2 times longer, then taken out after the stretching to be left to stand at room temperature for 24 hours, and thereafter further left to stand at any temperature within a range of 15 to 70° C. for 10 minutes. In Examples of the present invention, an adhesive comprising a (meth)acrylate-containing acrylic-based copolymer and a hardener added thereto is used as a specific example to describe how the temperature dependence of the birefringence of an adhesive can be expressed in a numerical form objectively by the measurement method described above.

Moreover, the present invention provides as further still yet another embodiment a method for designing/producing an adhesive for making it possible to form the special adhesive layer described above. That is, the present invention provides a method for designing/producing an adhesive in which both the birefringence and the temperature dependence of the birefringence are zero, wherein kinds and amounts of two or more monomer components for forming the copolymer that constitutes the adhesive are adjusted so that: a value of the birefringence of an adhesive Δn⁰ at room temperature is within a range of ±0.2×10⁻⁴, the value obtained by dividing retardation measured with a birefringence measuring apparatus for a sample stretched to 2 times by a thickness of an adhesive layer, wherein the sample is prepared in such a way that a laminated film, in which polymer films are used as supports, and the adhesive is given between two sheets of the supports to form the adhesive layer, is cut into a dumbbell shape to make the sample, and the sample is mounted on a tensile testing machine with a thermostatic chamber, heated at a temperature of 102° C. for 120 seconds, thereafter stretched at a tension speed of 40 mm/min until a marked line becomes 2 times longer, and then taken out after the stretching to be left to stand at room temperature for 24 hours; and the temperature coefficient of the birefringence of an adhesive dΔn⁰/dT is within a range of ±0.02×10⁻⁵/° C., the temperature coefficient measured by the method for measuring the temperature dependence of the birefringence described above.

Examples of the preferred embodiment of the method for designing/producing the above-described adhesive include the method for designing/producing the adhesive wherein the adhesive further comprises a crosslinking agent as a component that constitutes the adhesive, and the kind and the amount of the crosslinking agent are adjusted, and in Examples of the present invention, an adhesive comprising a (meth)acrylate-containing acrylic-based copolymer and a hardener added thereto is used as a specific example to describe the method for designing/producing an adhesive in which both the birefringence and the temperature dependence of the birefringence are zero.

### Advantageous Effects of Invention

According to the present invention, an excellent display can be provided in which a bend of the display and peeling of an optical film do not occur and lowering of the optical performance due to birefringence does not occur even when the display is used under an environment where a temperature change is large by using an adhesive in which the intrinsic birefringence is zero and the temperature dependence of the birefringence does not exist, which are made possible by a technique developed the present invention, and by pasting, for example, a glass plate and an optical film in which the temperature dependence of the birefringence is zero. Further, according to the present invention, an optically high-quality, excellent display can be provided which can realize that the birefringence does not occur in various forms of displays, such as a curved surface type display, a flexible display, and a foldable display, which are used in a state where the glass plate, the optical film, and the adhesive each being a constituent member of the displays are used in a deformed state and, further, the birefringence does not occur even if a deformed member is further subjected to a temperature change. The excellent effects described above can be achieved for the first time by providing the method for designing/producing an adhesive in which the birefringence of an adhesive is zero and the temperature dependence of the birefringence is zero, which are the properties that have never been existed conventionally, the method provided by a series of accumulated techniques comprising: utilizing a technique for providing the temperature-dependence-zero polymer film which has been newly found by the present inventors and in which the birefringence is zero (referred to as “temperature-dependence-zero-birefringence polymer) even when the birefringence is measured changing the temperatures; making it possible to quantify the temperature dependence of the birefringence of an adhesive by using this temperature-dependence-zero-birefringence polymer in evaluating an adhesive by the method described in Patent Literature 1; and further utilizing the novel quantification technique.

That the intrinsic birefringence Δn⁰ is “zero” in the present specification means that the intrinsic birefringence Δn⁰ is zero or close to zero, which is a numerical value specified in the present invention and regarded as zero. In addition, that “the temperature dependence of the intrinsic birefringence is reduced” means, when expressed in terms of the numerical value, that when the temperature of a uniaxially stretched film is controlled stepwise in a range of 15 to 70° C. to measure the intrinsic birefringence at each temperature, and from the obtained measurement results, a temperature coefficient of the intrinsic birefringence “dΔn⁰/dT” being an amount of change in the intrinsic birefringence per 1° C. is calculated, the absolute value is extremely small.

In “the adhesive in which both the birefringence and the temperature dependence of the birefringence are zero” specified in the present invention, which is essential for achieving the remarkable effects of the present invention, specific optical properties and the like exhibited in the adhesive and the adhesive layer formed with the adhesive will be described.

(1) Generally, when a phase difference in birefringence is 1 nm or more, light leakage and the like can be decided with naked eyes (by visual observation). Conversely, when the light leakage and the like cannot be recognized visually, it can be said that the birefringence is zero. In the “adhesive in which the temperature dependence of the birefringence is zero” specified in the present invention, the light leakage and the like cannot be recognized with naked eyes in any of the case where the adhesive is deformed and the case where the adhesive is subjected to a temperature change. From these facts, an adhesive having a property that the light leakage and the like cannot be recognized by naked-eye observation in any of the case where the adhesive is deformed and the case where the adhesive is subjected to a temperature change is referred to as “the adhesive in which both the birefringence and the temperature dependence of the birefringence are zero”.

(2) The deformation obtained when the adhesive itself is stretched to 2 times is smaller than the usual deformation of an adhesive that constitutes an adhesive layer of a display. Therefore, when the birefringence obtained in the case where the adhesive itself is stretched to 2 times is zero, it is considered that the birefringence in the adhesive layer in the display is also zero.

(3) A value of ±0.2×10⁻⁴ for the birefringence of an adhesive specified in the present invention means that, for example, the phase difference is ±0.4 nm in an adhesive layer having a thickness of 20 μm, and a value of ±0.02×10⁻⁵ for the temperature dependence specified in the present invention means that, for example, the phase difference becomes ±0.4 nm when the temperature changes by 100° C. in an adhesive layer having a thickness of 20 μm, and therefore it can be said that when the two are satisfied, there is no light leakage and the like when observation is conducted with naked eyes and both the birefringence and the temperature dependence of the birefringence are zero.

(4) The value of the intrinsic birefringence Δn⁰ for the adhesive in the present invention is specifically a value measured for a sample at room temperature by the method described below.

That is the value of the intrinsic birefringence Δn⁰ for the adhesive is a value obtained by dividing retardation measured with a birefringence measuring apparatus for a sample stretched to 2 times by the thickness of the adhesive layer, wherein the sample is prepared in such a way that a laminated film, in which polymer films are used as supports, and the adhesive is given between two sheets of the supports to form the adhesive layer, is cut into a dumbbell shape to make the sample, and the sample is mounted on a tensile testing machine with a thermostatic chamber, heated at a temperature of 102° C. for 120 seconds, thereafter stretched at a tension speed of 40 mm/min until a marked line becomes 2 times longer, and then taken out after the stretching to be left to stand at room temperature for 24 hours. It is to be noted that the birefringence of the polymer films used as the supports is almost zero and can be neglected and therefore the value measured as described above can be said as “the intrinsic birefringence for the adhesive”.

In addition, the dΔn⁰/dT being an index indicating the temperature dependence of the birefringence for the adhesive is determined by determining the birefringence of an adhesive at each temperature in the manner as described below and utilizing these values. Specifically, the dΔn⁰/dT is determined in the same method as described above except that a sample obtained by stretching the 2-hold stretched sample being an object of measuring the retardation with the birefringence measuring apparatus by the method described above while heating the 2-hold stretched sample is left to stand at room temperature, and thereafter, in measuring the retardation with the birefringence measuring apparatus, the obtained sample is placed at any temperature within a range of 15 to 70° C. for 10 minutes to thereafter measure the retardation. The value thus obtained is used as the birefringence of an adhesive at the temperature.

By a method for designing/producing an adhesive according to the present invention carried out in a manner as described below, the adhesive in which both the birefringence and the temperature dependence of the birefringence are zero can be obtained surely and stably. That is, firstly, the data of the intrinsic birefringence and the temperature dependence are obtained for various homopolymers each obtained by polymerizing one monomer selected in advance from among various kinds of monomers, the data of the intrinsic birefringence and the temperature dependence are obtained for various copolymers each obtained by polymerizing plural kinds of monomers taking the kinds and amounts of monomers into consideration from the obtained data for the homopolymers, and further, in addition to the above-described data, the data of the intrinsic birefringence and the temperature dependence are obtained for copolymers in which the combination of the kinds and amounts of the crosslinking agents is changed. Subsequently, the composition of an adhesive in which both the birefringence and the temperature dependence of the birefringence are considered to be zero is determined paying attention to the tendency of these data to obtain the adhesive. Evaluation on whether the birefringence and the temperature dependence of the birefringence in the obtained adhesive are zero can be conducted easily by deciding the light leakage and the like with naked eyes (by visual observation) as described in (1) to (3). A display comprising the adhesive obtained by conducting designing/producing in this way is a high-quality product in which the occurrence of the birefringence due to the deformation of the adhesive is suppressed and which is more excellent in the optical properties even when the display is used under an environment of a low temperature to a high temperature accompanied by a change in the environment such as a season and a place of use. The details about these will be described later.

### BRIEF DESCRIPTION OF DRAWINGS

FIG. 1 is a graph showing a relationship between the amount of various kinds of hardeners each added and the birefringence of an adhesive in adhesives prepared by adding various kinds of crosslinking agents (hardeners) to a copolymer synthesized using butyl acrylate (BA) and acrylic acid (AAc) in a ratio of 100/1.

FIG. 2 is a graph showing a relationship between the amount of various kinds of hardeners each added to a copolymer of BA/AAc=100/1 and the temperature dependence of birefringence of adhesives.

FIG. 3 is a graph showing a relationship between the birefringence of an adhesive and the temperature dependence of the birefringence in adhesives prepared by adding various kinds of hardeners to a copolymer synthesized using BA/AAc=100/1.

FIG. 4 is a graph showing a relationship between the amount of various kinds of hardeners each added and the birefringence of an adhesive in adhesives prepared by adding various kinds of hardeners to a copolymer synthesized using phenoxyethyl acrylate (PHEA), butyl acrylate (BA), and acrylic acid (AAc) in a ratio of 80/20/1.

FIG. 5 is a graph showing a relationship between the amount of various kinds of hardeners each added to a copolymer of PHEA/BA/AAc=80/20/1 and the temperature dependence of birefringence of an adhesive.

FIG. 6 is a graph showing a relationship between the birefringence of an adhesive and the temperature dependence of birefringence in adhesives prepared by adding various kinds of hardeners to a copolymer synthesized using PHEA/BA/AAc=80/20/1.

FIG. 7 is a graph showing a relationship between the birefringence of an adhesive and the temperature dependence of birefringence in each adhesive obtained in the case where a monomer ratio of BA and PHEA is changed and the kinds of hardeners added are two.

FIG. 8 is a graph showing a relationship between the amount of BA blended and the birefringence of an adhesive in each adhesive obtained in the case where a monomer ratio of BA and PHEA is changed and the kinds of hardeners added are two.

FIG. 9 is a graph showing a relationship between the amount of BA blended and the temperature dependence of birefringence of an adhesive in each adhesive obtained in the case where a monomer ratio of BA and PHEA is changed and the kinds of hardeners added are two.

FIG. 10 is a graph showing the temperature dependence of orientation birefringence Δnₒᵣ of a film formed with a polymer which is formed with a ternary copolymer P (MMA/TFEMA/BzMA=52.0/42.0/6.0) obtained by copolymerizing three kinds of monomers and which has an intrinsic birefringence of almost zero at 25° C. MMA is an abbreviation for methyl methacrylate, TFEMA is an abbreviation for 2,2,2-trifluoroethyl methacrylate, and BzMA is an abbreviation for benzyl methacrylate.

FIG. 11 is a graph showing the temperature dependence of the intrinsic birefringence Δn⁰ of the film shown in FIG. 10 and formed with the polymer which is obtained by copolymerizing the three kinds of monomers and which has an intrinsic birefringence of almost zero at 25° C.

### DESCRIPTION OF EMBODIMENTS

Next, the present invention will be described in detail giving preferred embodiments for carrying out the invention.

The present inventors have intended to develop a zero-birefringence adhesive in which birefringence does not occur even when the adhesive is deformed, and to check and evaluate whether an adhesive has such optical properties, the present inventors have first developed a temperature-dependence-zero-birefringence polymer (TZBP) which has never been able to be obtained by the conventional techniques even though the polymer is necessary for the evaluation, and in the polymer, the birefringence is zero even when the birefringence is measured fora stretched polymer film while changing the temperature. Specifically, for example, with respect to an optical resin material having a composite component system of two or more components including a binary or more copolymer system and a unary or more (co) polymer system, when the combination of the kinds of monomer components that constitutes the composite component system and their component ratio (composition ratio) are designed, the present inventors have found a method for reducing the temperature dependence in the intrinsic birefringence (namely, orientation birefringence property inherent in polymer) that affects the optical properties. The outline is described below.

The “orientation birefringence” herein generally refers to birefringence exhibited due to orientation of the main chain in a chain polymer (polymer chains), and for example, occurs in a process for producing a polymer film through extrusion molding/stretching or the like and in a process for producing various polymer optical devices/parts through injection molding or the like. The polymer chain orientated due to the stress in these molding processes generally exists in a state where the main chain is orientated in the polymer film because the orientated polymer chain cannot be relaxed while being subjected to cooling and solidifying, which is a source of the orientation birefringence.

Generally, this “orientation birefringence” can be measured with a commercially available birefringence measuring apparatus at room temperature after heating a polymer film being an object of the measurement to a temperature equal to or higher than the glass transition temperature, then uniaxially stretching the polymer film in a softened state, and subsequently subjecting the uniaxially stretched polymer film to cooling and solidifying. In the measurement, as shown in the following expression, the difference between the refractive index nₚ of the polymer main chain in the parallel direction to the uniaxially stretching direction and the refractive index n_{d} of the polymer main chain in the orthogonal direction to the uniaxially stretching direction, (nₚ−n_{d}), is defined as the orientation birefringence Δnₒᵣ, wherein the refractive index nₚ and the refractive index n_{d} are refractive indices of linearly polarized light having a polarization plane (plane including advancing direction of light and vibration direction of electric field) in a direction parallel with the uniaxially stretching direction and in a direction orthogonal to the uniaxially stretching direction, respectively.

Δnₒᵣ=(nₚ−n_{d})

The case where the Δnₒᵣ is not zero is referred to as “birefringence occurs”, and the value of the Δnₒᵣ is referred to as “orientation birefringence”. The case where the Δnₒᵣ is a positive value, namely the case where the refractive index in the parallel direction is larger, is referred to as “positive orientation birefringence”, and the case where the Δnₒᵣ is a negative value, namely the case where the refractive index in the orthogonal direction is larger, is referred to as “negative orientation birefringence”.

When the linearly polarized light enters the stretched film, a phase difference (retardation) occurs by the birefringence in the light passing through the stretched film when separated into two linearly polarized lights orthogonal to each other. The retardation Re holds the relationship with the orientation birefringence of the film and the thickness d of the film as shown in the following expression, and therefore the orientation birefringence Δnₒᵣ can be determined through calculation by dividing the results obtained by measuring the retardation by the film thickness d. The “intrinsic birefringence” Δn⁰ corresponds to the orientation birefringence when the degree of orientation is equal to 1, meaning that polymer molecules expand as much as possible and all the polymer molecules face the same direction, and is inherent in the kind of polymer.

Re=Δnₒᵣ×d

As mentioned previously, since the orientation birefringence is a value obtained as a result that the main chain exists in an orientated state in films/optical devices because the main chain cannot be relaxed while being subjected to cooling and solidifying after a polymer is molten, the present inventors considers that the selection of materials which are ideal in optical applications where the polarized light is utilized and in which the orientation birefringence does not occur becomes possible by studying this value of the “intrinsic birefringence” inherent in the kind of polymer in detail, and have conducted various studies.

The present inventors have measured the temperature dependence of the intrinsic birefringence of a polymer in the process of the studies and have obtained a new finding that the value of the intrinsic birefringence versus temperature is not constant and changes, and particularly, the amount of change becomes large as the temperature increases, which has never been recognized so far. Conventionally, the intrinsic birefringence of a polymer has usually been measured at room temperature. The intrinsic birefringence at room temperature has been regarded as a value inherent in the polymer, and various discussions have been made. For example, also, in the evaluation method in the method for designing an adhesive for obtaining zero-birefringence adhesive described in Patent Literature 1 previously explained, the value of the intrinsic birefringence in the zero-zero-birefringence polymer (ZZBP) film which is used for the support, which has an intrinsic birefringence value of equal to or less than 1×10⁻³ as the absolute value, which has an photoelastic constant of equal to or less than 1×10⁻¹² Pa⁻¹ as the absolute value, and in which the birefringence does not occur even when it is stretched and deformed, is a value at room temperature, and the birefringence that can be evaluated using this support is absolutely obtained at room temperature. In contrast, when the zero-birefringence polymer that is free of the temperature dependence can be obtained, the temperature dependence of the birefringence of an adhesive can be measured accurately by using the polymer film as the support.

The present inventors have conducted detailed studies to obtain a new finding that the rate of change in the intrinsic birefringence versus temperature (temperature coefficient of intrinsic birefringence) is also a characteristic that is inherent in a polymer, have found that polymer designing in which the temperature dependence in the intrinsic birefringence is taken into consideration and an influence due to the temperature change is suppressed can be realized by using the new finding, and have achieved a method for designing the following zero-birefringence polymer that is free of temperature dependence (TZBP). Specifically, the present inventors have found a technique for obtaining a copolymer (polymer) having a desired temperature dependence of the intrinsic birefringence by focusing the fact there are homopolymers having a positive temperature dependence of the intrinsic birefringence (temperature coefficient of intrinsic birefringence) and homopolymers having a negative temperature dependence of the intrinsic birefringence (temperature coefficient of intrinsic birefringence), appropriately selecting a repeating unit structure comprising a monomer composition to give a positive temperature dependence of the intrinsic birefringence and a monomer composition to give a negative temperature dependence of the intrinsic birefringence, and adjusting the monomer compositions to an appropriate copolymerization composition ratio.

The designing method for obtaining the zero-zero-birefringence polymer (ZZBP) film which is a copolymer having an intrinsic birefringence of almost zero at room temperature and having a photoelastic coefficient of zero is first described specifically taking a ternary copolymer comprising methyl methacrylate (MMA), 2,2,2-trifluoroethyl methacrylate (TFEMA), and benzyl methacrylate (BzMA) as an example.

The intrinsic birefringence Δn⁰ of the ternary copolymer synthesized so that the mass ratios of the above-described three kinds of monomer components are W_{PMMA}, W_{PTFEMA}, and W_{PBzMA} is determined by the following expression (1) using each intrinsic birefringence of a homopolymer synthesized from each monomer. Moreover, the photoelastic constant C of the ternary copolymer synthesized so that the mass ratios of the above-described monomers are W_{PMMA}, W_{PTFEMA}, and W_{PEzMA} is determined by the following expression (2) using each photoelastic constant of a homopolymer synthesized from each monomer. The following formula (3) is an expression showing the monomer composition of the ternary copolymer and shows that the three kinds of monomer components are copolymerized in the mass ratios (%) of W_{PMMA}, W_{PTFEMA}, and W_{PBzMA}.

$$\begin{matrix}Δ {n}^{0} = Δ {n}_{PMMA}^{0} \times \frac{{W}_{PMMA}}{100} + Δ {n}_{PTFEMA}^{0} \times \frac{{W}_{PTFEMA}}{100} + Δ {n}_{PBzMA}^{0} \times \frac{{W}_{PBzMA}}{100} & ( 1 ) \\ C = {C}_{PMMA} \times \frac{{W}_{PMMA}}{100} + {C}_{PTFEMA} \times \frac{{W}_{PTFEMA}}{100} + {C}_{PBzMA} \times \frac{{W}_{PBzMA}}{100} & ( 2 ) \\ 100 = {W}_{PMMA} + {W}_{PTFEMA} + {W}_{PBzMA} & ( 3 )\end{matrix}$$

In the expression (1), Δn⁰_{PMMA} represents the intrinsic birefringence of a homopolymer of MMA (PMMA), Δn⁰_{PTFEMA} represents the intrinsic birefringence of a homopolymer of TFEMA (PTFEMA), and Δn⁰_{PBzMA} represents the intrinsic birefringence of a homopolymer of BzMA (PBzMA). In addition, in the expression (2), C_{PMMA} represents the photoelastic constant of the homopolymer of MMA, C_{PTFEMA} represents the photoelastic constant of the homopolymer of TFEMA, and C_{PBzMA} represents the photoelastic constant of the homopolymer of BzMA.

The value of the intrinsic birefringence Δn⁰ of the ternary copolymer in the left side of the expression (1) is set to zero (Δn⁰=0), and the value of the photoelastic constant C of the ternary copolymer in the left side of the expression (2) to set up simultaneous equations with the expression (3) and solve them to determine a monomer composition of MMA, TFEMA, and BzMA as W_{PMMA}/W_{PTFEMA}/W_{PBzMA}=52.0/42.0/6.0, the composition making the synthesis of a polymer in which both the intrinsic birefringence Δn⁰ and the photoelastic constant C are zero (hereinafter, also referred to zero-zero-birefringence polymer) possible. The ternary copolymer comprising such a monomer composition is actually synthesized, and the intrinsic birefringence and the photoelastic constant thereof are measured to be almost zero under a condition of a temperature of 25° C.

(Method for Measuring Birefringence)

The “intrinsic birefringence of a polymer” in the present specification is measured by a method as described below. A film is first prepared by adjusting a solution of a polymer being an object of the measurement using an appropriate organic solvent, the orientation birefringence and the degree of orientation thereof are measured in the manner as described below using the obtained film to determine the intrinsic birefringence of a polymer from these measured values. Description is made below taking the ternary polymer comprising the above-described monomers as an example. The obtained polymer is first put into a sample tube made of glass with tetrahydrofuran in an amount that is four-times larger than that of the polymer as the mass ratio and the resultant mixture is stirred and dissolved sufficiently. The polymer solution is spread on a glass plate using a knife coater so that the thickness is about 0.3 mm to be left to stand and dried for one day at room temperature. Subsequently, the obtained film is peeled from the glass plate and further dried for 48 hours in a vacuum dryer at 60° C., and the obtained polymer film having a thickness of about 40 μm is processed into a dumbbell shape to perform uniaxial stretching with a TENSILON general-purpose testing machine (manufactured by ORIENTEC CORPORATION). On this occasion, some films each having a different degree of orientation are prepared at a stretching temperature in a range of 120 to 140° C., at a stretching speed in a range of 2 to 30 mm/min, in a stretching ratio in a range of 1.1 to 3.0, and the like. The orientation birefringence of the film after the stretching is measured with an automatic birefringence measuring apparatus ABR-10A (manufactured by Uniopt Co., Ltd.). Moreover, the degree of orientation of the film after the stretching is measured by an infrared 2-band absorption method. The intrinsic birefringence of the polymer is determined by dividing (or extrapolating) the value of the orientation birefringence measured in the manner as described above by the degree of orientation of the film after the stretching. It is to be noted that the intrinsic birefringence of the film made of the polymer, measured by the method as described above, is 0.16×10⁻³ at 25° C. and is regarded as almost zero at room temperature.

(Temperature Dependence of Intrinsic Birefringence)

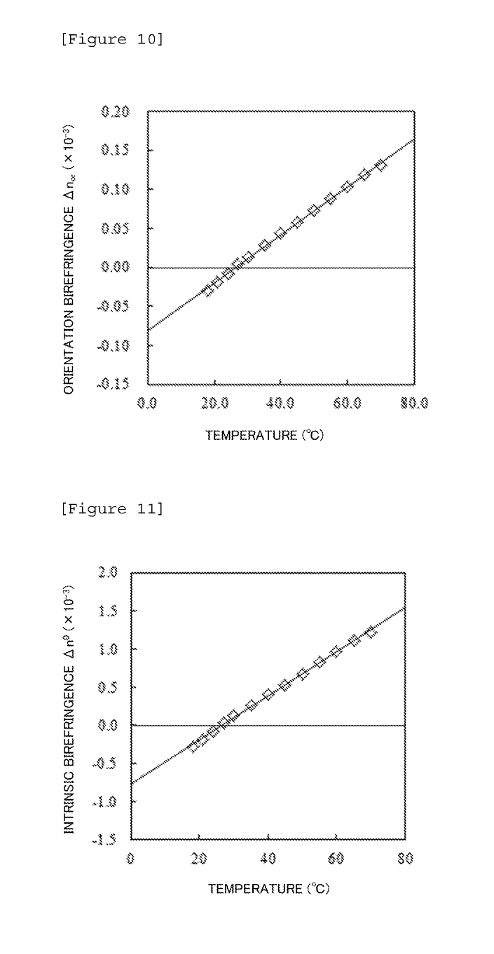

The temperature dependence of the intrinsic birefringence of a sample is investigated while controlling the temperature at 15° C. to 70° C., wherein the sample is obtained in such a way that the polymer which comprises the ternary copolymer (MMA/TFEMA/BzMA=52.0/42.0/6.0) obtained as described above and which has an intrinsic birefringence of almost zero is used, and the polymer is hot-stretched by 40 mm at 102° C. and at 40 mm/min and is left to stand at room temperature for 24 hours. Specifically, the retardation (Re) is measured when the temperature is raised with a temperature-controlling apparatus. FIG. 10 shows the results of measuring the orientation birefringence. The orientation birefringence is determined by dividing the measured retardation by the film thickness of 28 μm. Further, the orientation birefringence divided by the degree of orientation of the polymer chain in the polymer film, f=0.107, is the intrinsic birefringence shown in FIG. 11. As understood from these figures, the birefringence is zero at around room temperature of 25° C., but the birefringence increases as the temperature increases. As also understood from these figures, this temperature dependence relatively holds a linear relationship with the temperature. Moreover, it is found that the thickness of a general protective film for a polarizing plate of 80 μm multiplied by the value of the orientation birefringence of 0.10×10⁻³ corresponds to a retardation of 8 nm. Generally, the retardation of 1 nm can be visually recognized when a polymer film is placed between crossed Nicols (polarizing plates orthogonal to each other), and therefore it is found that the influence of the change in birefringence due to this change in temperature is large.

(Studies on Temperature Dependence of Intrinsic Birefringence of Polymers)

From the above results, the present inventors have conducted similar tests for optical films of various kinds of monomer compositions to investigate the temperature dependence of the intrinsic birefringence. As a result, it has been ascertained that both the polymers exhibiting a positive intrinsic birefringence at room temperature and the polymers exhibiting a negative intrinsic birefringence have the temperature dependence. In addition, it has been found that even in the cases, for example, where the intrinsic birefringence exhibits a positive correlation with the temperature, the extent of the correlation is not uniform and is different depending on the monomer composition for forming the polymer. To study the difference in the extent, the degree of correlation has been compared by the change in the amount of Δn⁰ per 1° C. for homopolymers corresponding to various kinds of monomers. Table 1 illustrates the results of the value of the intrinsic birefringence Δn⁰ at 25° C. (room temperature) and the temperature coefficient of the intrinsic birefringence dΔn⁰/dT which is obtained by conducting the measurement while controlling the temperature from 15° C. to 70° C. and which represents the change in the amount of Δn⁰ per 1° C. for each polymer. As a result, it has been recognized that there is a tendency that the degree of correlation with temperature depends on the side chain structure of each polymer. For example, it has been suggested that the degree of correlation with the temperature be low for polymers having a bulky side chain structure and be high for polymers having a structure which is not bulky but which has a large polarization anisotropy. In Table 1, PPhMA is an abbreviation fora homopolymer of phenyl methacrylate, PMI is an abbreviation for a homopolymer corresponding to polymaleimide, PMeMI is an abbreviation for a homopolymer corresponding to a poly(methylmaleimide), PEMI is an abbreviation for a homopolymer corresponding to poly(ethylmaleimide), PCHMI is an abbreviation for a homopolymer corresponding to poly(cyclohexylmaleimide), and the others are each the abbreviation for the same homopolymer as mentioned previously.

TABLE 1
Temperature dependence of intrinsic
birefringence of homopolymers

| | Intrinsic birefringence | |
|---|---|---|
| Polymer | Δn⁰ (×10⁻³) | dΔn⁰/dT (×10⁻⁵ ° C.⁻¹) |
| PMMA | −5.6 | 3.1 |
| PBzMA | 17.2 | −1.5 |
| PPhMA | −10.9 | −2.1 |
| PMI | 93.1 | 1.1 |
| PMeMI | 53.8 | −0.9 |
| PEMI | 51.9 | −2.1 |
| PCHMI | 19.5 | 0.4 |

The polymer film which is used in designing/producing the adhesive free of the temperature dependence of the birefringence in the present invention and in which the temperature dependence of the birefringence is reduced can be produced easily by the method as described below. For example, a resin material which has an intrinsic birefringence of almost zero and which is useful as the polymer film in which the temperature dependence of the intrinsic birefringence is reduced can be obtained by the method as described below in the case of the copolymer comprising three kinds of monomers. The kinds of monomers that can form the polymer having an intrinsic birefringence of almost zero are first selected by the method as mentioned previously. It is assumed here that three kinds of monomers from the first to the third monomer are selected. Subsequently, the temperature dependence of the birefringence is investigated by the method as described previously for each film consisting of a homopolymer corresponding to each of the three kinds of monomers to determine the temperature coefficient of the intrinsic birefringence dΔn⁰/dT for each film. The simultaneous equations of the following (i) to (iii) are set up assuming that the mass fractions (%) of the three kinds of monomers from the first monomer to the third monomer are W₁, W₂, and W₃, respectively. Subsequently, by determining solutions of W₁, W₂, and W₃ setting the left side of expression (i) to zero (Δn⁰=0) and setting the left side of expression (ii) to zero (dΔn⁰/dT=0), the polymer which has an intrinsic birefringence of almost zero, which has a temperature coefficient of the intrinsic birefringence of zero, and which is free of the temperature dependence in the orientation birefringence can be obtained. Moreover, on this occasion, a polymer film in which the orientation birefringence is adjusted to a desired value and the temperature dependence of the orientation birefringence is reduced can be obtained by setting the value in the left side of expression (i) and the value in the left side of formula (ii) to a desired value.

$$\begin{matrix}Δ {n}^{0} = Δ {n}_{1}^{0} \times \frac{{W}_{1}}{100} + Δ {n}_{2}^{0} \times \frac{{W}_{2}}{100} + Δ {n}_{3}^{0} \times \frac{{W}_{3}}{100} & ( i ) \\ \frac{d Δ {n}^{0}}{dT} = \frac{d Δ {n}_{1}^{0}}{dT} \times \frac{{W}_{1}}{100} + \frac{d Δ {n}_{2}^{0}}{dT} \times \frac{{W}_{2}}{100} + \frac{d Δ {n}_{3}^{0}}{dT} \times \frac{{W}_{3}}{100} & ( ii ) \\ 100 = {W}_{1} + {W}_{2} + {W}_{3} & ( iii )\end{matrix}$$

Next, the present inventors have conducted further studies to make it possible to design/produce the adhesive which is free of the temperature dependence of the birefringence by evaluating the adhesive utilizing the technique described in Patent Literature 1 with the polymer films which are obtained in the manner as described above, which have an extremely small intrinsic birefringence when stretched and deformed, and which have a reduced temperature dependence of the intrinsic birefringence. Specifically, a laminated film in which the polymer films are used as supports and the adhesive is given to the supports is prepared, and the laminated film is then hot-stretched to measure the retardation of the laminated film after the hot-stretching. On the other hand, the thickness of the adhesive layer is measured, and a value obtained by dividing the retardation by the thickness is determined to be the birefringence of an adhesive for the adhesive. In determining the birefringence of an adhesive, the polymer films each prepared by the above-described method, each having an intrinsic birefringence within a range of ±0.05×10⁻⁴ when uniaxially stretched and each having a temperature coefficient of the intrinsic birefringence dΔn⁰/dT at 25° C. to 60° C. within a range of ±0.005×10⁻⁵ are used, wherein the temperature coefficient of the intrinsic birefringence is determined as an amount of change in the intrinsic birefringence per 1° C. from measurement results obtained in such a way that the uniaxially stretched film is used, a temperature of the film is controlled stepwise in a range of 25° C. to 60° C. to measure an intrinsic birefringence Δn⁰ at each temperature.

By measuring the birefringence in such a way that the temperature-dependence-zero-birefringence polymer (TZBP) which is constituted in the manner as described above, in which the birefringence does not occur even after being stretched and deformed, in which the temperature dependence of the intrinsic birefringence is reduced, and in which the birefringence is zero is utilized as the support, and the composite (laminated) film obtained by sandwiching the adhesive being the object of measurement between two sheets of the polymer films is stretched, the birefringence for the adhesive can be measured without being affected by the temperature dependence in the supports. Because of these studies, the adhesive which is free of the temperature dependence of the birefringence of the adhesive can be prepared by appropriately adjusting the composition for copolymerization in the adhesive and the kinds and amounts of the additive such as a plasticizer and the crosslinking agent as will be described later.

The constituent material of the adhesive that characterizes the present invention is not different at all from constituent materials used in the conventionally known adhesive compositions for optical use, and examples thereof include a constituent material obtained by adding an additive such as a crosslinking agent to the (meth)acrylate-containing acrylic-based copolymer or the like. The important thing in the adhesive according to the present invention is that, as described previously, the adhesive is constituted so that the measured value of the birefringence of an adhesive Δn⁰ is within a range of ±0.2×10⁻⁴, and the temperature coefficient of the birefringence of an adhesive dΔn⁰/dT is within a range of ±0.02×10⁻⁵, wherein the birefringence of an adhesive and the temperature coefficient of the birefringence of an adhesive are measured in such a way that the kinds and amounts of the monomer components each being a constituent material of the adhesive, and further, in the case where the crosslinking agent is added, adjusting the kind and amount of the crosslinking agent and by the measurement method described previously. As described previously, “the adhesive in which both the birefringence and the temperature dependence of birefringence are zero” satisfying the above specifications means, in other words, the adhesive that exhibits an optical property that the light leakage and the like are not recognized by naked eyes in any of the case where the adhesive is deformed and the case where the adhesive is subjected to a temperature change.

Examples of the constituent material of the adhesive that characterizes the present invention include a (meth)acrylate-containing acrylic-based copolymer having a weight average molecular weight of 400000 to 2000000. Examples of the monomer used in the acrylic-based copolymer include: alkyl(meth)acrylate monomers such as methyl (meth)acrylate, ethyl (meth)acrylate, propyl (meth)acrylate, butyl (meth)acrylate, isobutyl (meth)acrylate, 2-ehtylhexyl (meth)acrylate, octyl (meth)acrylate, isooctyl (meth)acrylate, isononyl (meth)acrylate, and lauryl (meth)acrylate; aromatic group-containing (meth)acrylate monomers such as phenoxyethyl (meth)acrylate and benzyl (meth)acrylate; carboxy group-containing (meth)acrylate monomers such as (meth)acrylic acid and carboxyethyl (meth)acrylate; hydroxy group-containing (meth)acrylate monomers such as N-(2-hydroxyethyl) (meth)acrylamide, 2-hydroxyethyl (meth)acrylate, 2-hydroxypropyl (meth)acrylate, 4-hydroxybutyl (meth)acrylate, 2-hydroxybutyl (meth)acrylate, caprolactone-modified (meth)acrylate, polyethylene glycol mono(meth)acrylate, and polypropylene glycol mono(meth)acrylate; and amino group-containing (meth)acrylate monomers such as dimethylaminoethyl (meth)acrylate.

Further, a monomer which is listed below and comprises a reactive unsaturated double bond that is copolymerizable with the monomer listed above can also be appropriately selected for use as a constituent component. Examples thereof include: carboxy group-containing monomers such as acrylic acid, itaconic acid, maleic acid, and fumaric acid; acid anhydride monomers such as maleic anhydride and fumaric anhydride; amide group-containing monomers such as (meth)acryl amide; aromatic group-containing monomers such as styrene and methylstyrene; and vinyl acetate and (meth)acrylonitrile. It is to be noted that with respect to the (meth)acrylate-containing copolymer formed from the monomers as listed above, the sequence rule of the monomers is not particularly limited and any of random copolymers, block copolymers, and other copolymers may be used.

The adhesive according to the present invention can be made to have the constitution in which a crosslinking agent as listed below is added; however, as will be mentioned later, the birefringence of an adhesive Δn⁰ and the temperature dependence of the birefringence of an adhesive may be affected depending on the kind and amount of the crosslinking agent to be added, and therefore, in the case where the crosslinking agent is used, it is necessary to design/produce the adhesive taking this point of view into consideration. Examples of the crosslinking agent include a crosslinking agent selected from the group consisting of isocyanate-based crosslinking agents, epoxy-based crosslinking agents, metal-based crosslinking agents, and aziridine-based crosslinking agents. Specific examples thereof include polyglycidyl compounds having two or more glycidyl groups in one molecule, polyisocyanate compounds having two or more isocyanate groups in one molecule, polyaziridine compounds having two or more aziridinyl groups in one molecule, polyoxazoline compounds having two or more oxazoline groups in one molecule, metal chelate compounds, and butylated melamine compounds. These may be used singly or in a combination of two or more.

Examples of the polyglycidyl compounds include multifunctional glycidyl compounds such as ethylene glycol diglycidyl ether, polyethylene glycol diglycidyl ether, propylene glycol diglycidyl ether, polypropylene glycol diglycidyl ether, glycerin diglycidyl ether, neopentyl glycol diglycidyl ether, 1,6-hexanediol diglycidyl ether, N,N,N′,N′-tetraglycidyl-m-xylenediamine, 1,3-bis(N,N-diglycidyl aminomethyl)cyclohexane, trimethylolpropane polyglycidyl ether, and diglycerol polyglycidyl ether.

Examples of the polyisocyanate compounds include tolylene diisocyanate, xylene diisocyanate, hydrogenated xylene diisocyanate, hexamethylene diisocyanate, isophorone diisocyanate, and modified prepolymers derived therefrom.

Examples of the polyaziridine compounds include 1,1′-(methylene-di-p-phenylene) bis 3,3-aziridyl urea, 1,1′-(hexamethylene) bis-3,3-aziridyl urea, ethylene bis-(2-aziridinyl propionate), tris(1-aziridinyl) phosphine oxide, 2,4,6-triaziridinyl-1,3,5-triazine, and trimethylolpropane-tris-(2-aziridinyl propionate), and at least one selected from the group consisting of these can be used.

It is not preferable that the amount of the crosslinking agent added is too small because the cohesive force of the adhesive may be lowered and the durability as the adhesive may become inferior. On the other hand, it is not preferable that the amount of the crosslinking agent added is too large because the cohesive force of the resultant adhesive may become excessive to cause peeling of an optically functional film to be adhered. Accordingly, in designing the adhesive in which the crosslinking agent is used so that both the birefringence and the temperature dependence of the birefringence become zero, it becomes necessary to determine the amount of the crosslinking agent taking these viewpoints into consideration for making the performance as the adhesive good.

### Examples

Hereinafter, the present invention will be described more specifically giving Examples and Comparative Examples. It is to be noted that “parts” and “%” in the description below are on a mass basis unless otherwise noted.

<Method for Measuring Temperature Dependence of Birefringence of Adhesive>

### (1) Production of Temperature-Dependence-Zero-Birefringence Polymer Film

A temperature-dependence-zero-birefringence polymer (TZBP) in which the birefringence is zero even when the birefringence is measured for a stretched polymer film while changing the temperature was first prepared in the manner as described below. It is to be noted that a ternary monomer composition for forming this polymer was derived by the method described previously.

The monomer composition was set so that the ratio of methyl methacrylate (MMA)/phenyl methacrylate (PhMA)/benzyl methacrylate (BzMA) in terms of mass parts was 43.5/23.5/33, and the monomers were polymerized using 0.1 parts of azobisisobutyronitrile (AIBN) as a polymerization initiator in 5 parts of acetone and 70 parts of ethyl acetate. After the polymerization, 158.1 parts of ethyl acetate was added to prepare a copolymerized polymer solution.

The copolymerized polymer solution was applied on a separator so that the dried film thickness was 40 μm, and the applied solution was then dried at 50° C. for 10 minutes. After the drying, the separator was peeled, and the intrinsic birefringence and the temperature dependence of the birefringence of the obtained polymer film were measured. As a result, the intrinsic birefringence of the obtained polymer film was Δn⁰=−0.01×10⁻⁴. Moreover, the temperature dependence coefficient of the intrinsic birefringence was dΔn⁰/dT=0.004×10⁻⁵ to find that the obtained polymer film is a polymer (TZBP) film in which both the intrinsic birefringence and the temperature dependence of the birefringence are almost zero.

### (2) Method for Measuring Birefringence and Temperature Dependence of Birefringence of Polymer Film

The birefringence and the temperature dependence of the birefringence for the polymer film prepared above were determined by the method described below. The prepared film was die-cut into a dumbbell shape, and the dumbbell shaped film was left to stand at 108° C. for 2 minutes and then stretched to 2 times at a tension speed of 40 mm/min using a tensile testing machine with a thermostatic chamber, and thereafter the temperature was returned to room temperature (25° C.). The phase difference of the stretched film was measured using a photoelasticity measurement apparatus (PEL-3A-102C (trade name)) manufactured by Uniopt Co., Ltd. with He—Ne laser of 633 nm at 25° C., at 40° C., and at 60° C., and the phase difference was divided by the thickness of the film after the stretching to measure the orientation birefringence Δnₒᵣ. The intrinsic birefringence Δn⁰ is obtained by further dividing the orientation birefringence by the degree of orientation of the molecular chain of the polymer in the polymer film. Further, the temperature dependence coefficient of the birefringence dΔn⁰/dT was determined as the amount of change in the intrinsic birefringence per 1° C. from the values of the intrinsic birefringence at 25° C., at 40° C., and at 60° C. In the present invention, the above-described photoelasticity measurement apparatus was used as a birefringence measurement apparatus for measuring the retardation in all the cases.

### (3) Preparation of Adhesive and Measurement of Birefringence of Adhesive

A plurality of predetermined monomers were first weighed to obtain a predetermined composition ratio, and the plurality of monomers were polymerized using AIBN as an initiator in ethyl acetate to produce a polymer solution. A predetermined hardener was added to this polymer solution to prepare an adhesive. The prepared adhesive was applied on PET separators so that the dried film thickness was 25 μm, the applied adhesive was then dried at 90° C. for 3 minutes, and thereafter the PET separators were adhered to each other and was then subjected to aging in a room of 23° C. and 50% RH.

After the aging, the separators of the adhesive were peeled, and the TZBP films obtained previously were adhered to both sides of the adhesive. The thickness of the laminated (composite) film was 105 μm. The birefringence and the temperature dependence of the birefringence for the laminated film thus obtained were determined in the manner as described below. Since both the intrinsic birefringence and the temperature dependence of the birefringence in the TZBP films constituting the laminated film used for the measurement herein are zero as described previously, the phase difference (retardation) of the stretched composite film measured in the manner as described below means the birefringence derived only from the adhesive. Accordingly, a value obtained by dividing the value of the phase difference by the thickness of the adhesive after the stretching can be regarded as the birefringence of the adhesive stretched to 2 times. Thus, the value determined in the manner as described below was determined to be the birefringence of an adhesive at room temperature (25° C.)

The laminated film which was prepared above, which has the adhesive being the object of the measurement and being interposed between two sheets of TZBP films having a dried film thickness of 40 μm, and which has a thickness of 105 μm was cut into a dumbbell shape to prepare a sample for the measurement. It is found from above that the thickness of the adhesive layer is 25 μm. This dumbbell shaped sample was mounted on the tensile testing machine with a thermostatic chamber, heated at a temperature of 102° C. for 120 seconds, and thereafter stretched at a tension speed of 40 mm/min until a marked line becomes 2 times longer. Thereafter, the sample stretched to 2 times was taken out to be left to stand at room temperature (25° C.), and the retardation was measured for the sample 24 hours after it was left to stand with the birefringence measurement apparatus. A value was determined by dividing this measured value of the retardation at room temperature for the sample stretched to 2 times by the thickness of the adhesive layer to be the birefringence of an adhesive Δn⁰.

Further, when the measurement of the retardation was conducted with the birefringence measuring apparatus, the room-temperature sample which was prepared in the manner as described above and which was stretched to 2 times was retained at a temperature of 40° C. or 60° C. for 10 minutes, and thereafter the measurement was conducted, thereby determining the intrinsic birefringence of the adhesive at each temperature of 40° C. or 60° C. From these values and the birefringence of an adhesive at room temperature (25° C.) obtained previously, the temperature dependence of the birefringence as the amount of change in the birefringence of an adhesive per 1° C. was determined. It is to be noted that the thickness of the adhesive after being stretched to 2 times was calculated from the thickness of the laminated film which was stretched. In the case where the thickness of the laminated film after being stretched is 80 μm, the thickness of the adhesive after being stretched is 25 μm×80/105=19 μm.

<Studies on Influence of Difference in Kind and Amount of Crosslinking Agent Constituting Adhesive on Intrinsic Birefringence of Adhesive and Temperature Dependence>

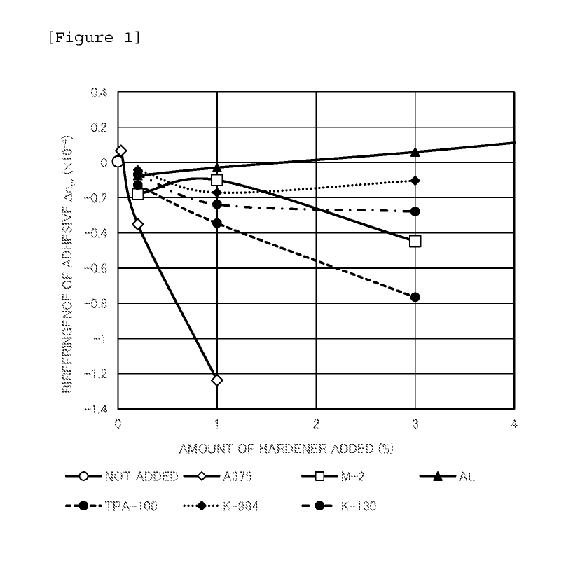

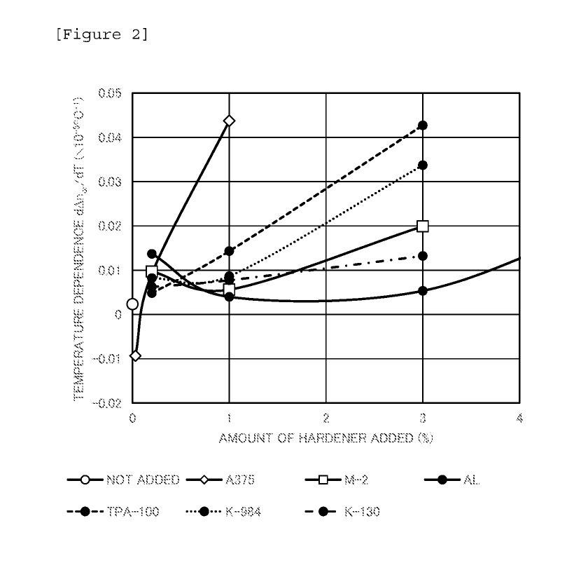

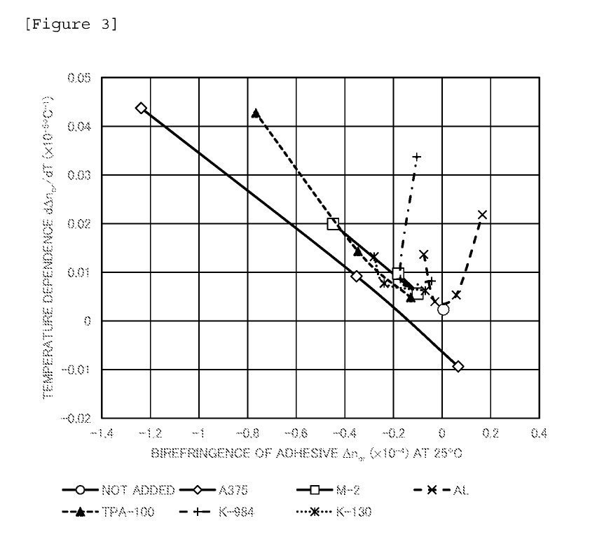

In the preparation of the adhesive described previously, butyl acrylate (BA) and acrylic acid (AAc) were used to set the ratio in terms of mass parts to 100/1 as the monomer composition in producing the polymer solution. The kind and amount of the crosslinking agent to be added to the obtained polymer solution was changed as shown in Table 2 to prepare each adhesive. The gel fraction of each adhesive obtained was measured, and it is shown in Table 2. The birefringence of an adhesive and the temperature dependence of the birefringence were determined in the same manner as described previously for each adhesive obtained. The obtained results are shown in Table 2. From there results, as shown in FIG. 3, it was ascertained that adding a hardener affects the birefringence of an adhesive and the temperature dependence of the birefringence irrespective of the kind of the crosslinking agent. Further, it was found that the extent of the influence is different depending on the kind of the crosslinking agent. Moreover, as shown in FIGS. 1 and 2, a tendency was recognized that the influence becomes large when the amount of the crosslinking agent added becomes large although the influence depends on the kind of the crosslinking agent. Among the crosslinking agents used in the studies, it was found that K-130 and M-2 have less influence on the birefringence of an adhesive and the temperature dependence of the birefringence than the other crosslinking agents. On the other hand, A375 and TPA-100 had larger influence on the birefringence of an adhesive and the temperature dependence of the birefringence than the other crosslinking agents.

The crosslinking agents which were used in the above tests and which are abbreviated in Tables 2 to 4 are as follows.

AL: CORONATE L-45E (trade name, manufactured by Tosoh Corporation, TDI-based polyisocyanate)

A375: Product obtained by diluting TETRAD-C (trade name, manufactured by MITSUBISHI GAS CHEMICAL COMPANY, INC., multifunctional epoxy resin) to 2% with ethyl acetate/toluene

M-2: Product obtained by diluting Aluminum Chelate A (trade name, manufactured by Kawaken Fine Chemicals Co., Ltd., aluminum tris-acethylacetonate) to 5% with toluene/IPA/acetylacetone

TPA-100: Duranate TPA-100 (trade name, manufactured by Asahi Kasei Corp., HDI-based polyisocyanate)

K-984: Desmodur IL-1451 (trade name, manufactured by Bayer AG, TDI-based polyisocyanate)

K-130: Duranate E-405-80T (trade name, manufactured by Asahi Kasei Corp., HDI-based polyisocyanate)

Plasticizer: ADK CIZER PN-6120 (trade name, manufactured by ADEKA CORPORATION, ADEKA polyester-based plasticizer)

TABLE 2
Birefringence of adhesive and temperature dependence in
the case where kind and amount of hardener are changed
Monomer composition ratio of copolymer: BA/AAc = 100/1

| | Addition | Gel | Birefringence | Temperature |
|---|---|---|---|---|
| Kind of | (s/s) | fraction | of adhesive | dependence |
| hardener | (%) | (%) | Δnₒᵣ × 10⁻⁴ | dΔnₒᵣ/dT × 10⁻⁵ ° C.⁻¹ |
| AL | 0.2 | 0 | −0.075 | 0.0137 |
| | 1 | 36.5 | −0.030 | 0.0040 |
| | 3 | 58.2 | 0.059 | 0.0053 |
| | 5 | 62.6 | 0.166 | 0.0218 |
| A375 | 0.03 | 70.8 | 0.066 | −0.0093 |
| | 0.2 | 89.5 | −0.352 | 0.0092 |
| | 1 | 94.5 | −1.238 | 0.0437 |
| M-2 | 0.2 | 84 | −0.180 | 0.0097 |
| | 1 | 97.1 | −0.100 | 0.0056 |
| | 3 | 96.2 | −0.448 | 0.0199 |
| TPA-100 | 0.2 | 63.5 | −0.129 | 0.0048 |
| | 1 | 83.3 | −0.346 | 0.0143 |
| | 3 | 94.6 | −0.766 | 0.0427 |
| K-984 | 0.2 | 80 | −0.043 | 0.0082 |
| | 1 | 70.8 | −0.172 | 0.0087 |
| | 3 | 86.3 | −0.104 | 0.0337 |
| K-130 | 0.2 | 71.2 | −0.069 | 0.0062 |
| | 1 | 76.9 | −0.238 | 0.0077 |
| | 3 | 88 | −0.279 | 0.0132 |
| Not added | 0 | 0 | 0.005 | 0.0023 |

<Studies on Influence of Difference in Kind and Amount of Crosslinking Agent on Intrinsic Birefringence of Adhesive and Temperature Dependence in the Case where Composition of Raw Material Monomers for Copolymer Constituting Adhesive is Changed>

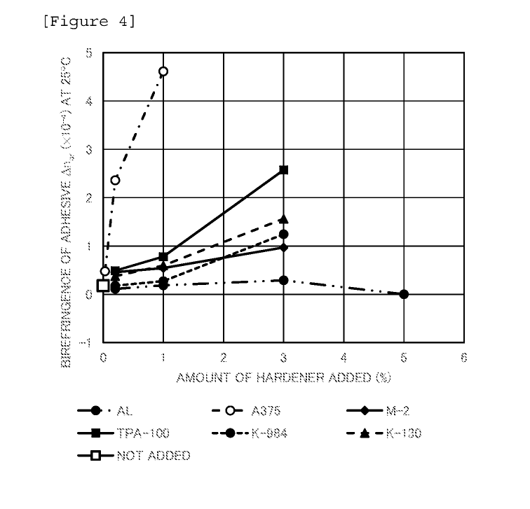

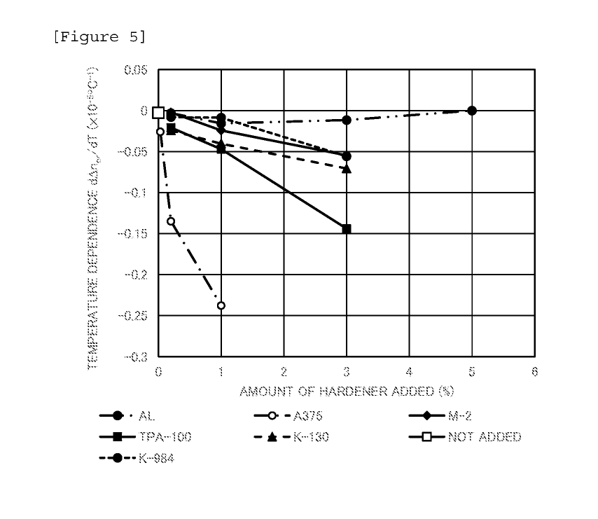

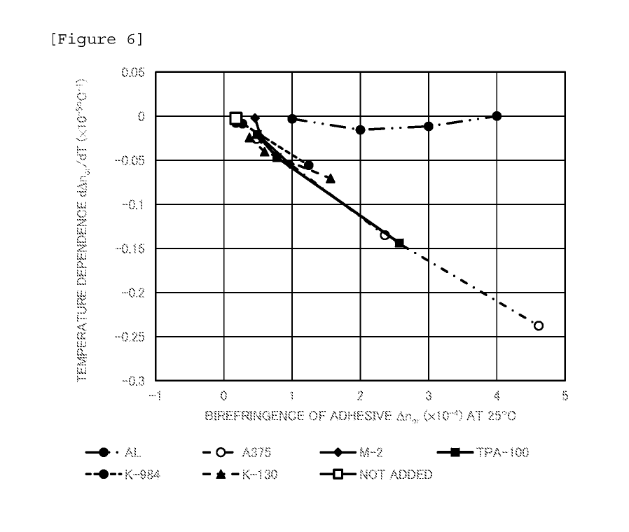

In the preparation of the adhesive described previously, phenoxyethyl acrylate (PHEA), butyl acrylate (BA), and acrylic acid (AAc) were used to set the ratio in terms of mass parts to 80/20/1 as the monomer composition in producing the polymer solution. The kind and amount of the crosslinking agent to be added to the obtained polymer solution was changed as shown in Table 3 to prepare each adhesive. The gel fraction of each adhesive obtained was measured, and it is shown in Table 3. The birefringence of an adhesive and the temperature dependence of the birefringence were determined in the same manner as described previously for each adhesive obtained. The obtained results are shown in Table 3. From there results, as shown in FIG. 6, it was ascertained that adding a hardener affects the birefringence of an adhesive and the temperature dependence of the birefringence irrespective of the kind of the crosslinking agent. The tendency is different in many points when compared with the case shown in FIG. 3, and it was found that the selection of the monomer composition in producing a polymer solution is an important factor as well as the selection of the kind of the crosslinking agent in order to obtain the adhesive in which both the birefringence and the temperature dependence of the birefringence are zero and which the present invention intends to provide. Also, as shown in FIGS. 4 and 5, in the case where the polymer solution was used, a tendency was recognized that as the amount of the crosslinking agent added becomes large, the influence thereof becomes large although the tendency depends on the kind of the crosslinking agent. Also, in this case, among the crosslinking agents used in the studies, A375 and TPA-100 had larger influence on the birefringence of an adhesive and the temperature dependence of the birefringence than the other crosslinking agents. In addition, it was found that among the crosslinking agents used in the studies, M-2, K-130, and K-984 have less influence on the birefringence of an adhesive and the temperature dependence of the birefringence than the other crosslinking agents.

TABLE 3
Birefringence of adhesive and temperature dependence in
the case where kind and amount of hardener are changed
Monomer composition ratio of copolymer: PHEA/BA/AAc = 80/20/1

| | Addition | Gel | Birefringence | Temperature |
|---|---|---|---|---|
| Kind of | (s/s) | fraction | of adhesive | dependence |
| hardener | (%) | (%) | Δnₒᵣ × 10⁻⁴ | dΔnₒᵣ/dT × 10⁻⁵ ° C.⁻¹ |
| AL | 0.2 | 0 | 0.112 | −0.0031 |
| | 1 | 41.7 | 0.184 | −0.0156 |
| | 3 | 70.6 | 0.289 | −0.0116 |
| | 5 | 67.8 | — | — |
| A375 | 0.03 | 68.5 | 0.477 | −0.0259 |
| | 0.2 | 89.1 | 2.359 | −0.1350 |
| | 1 | 93.6 | 4.614 | −0.2377 |
| M-2 | 0.2 | 75.3 | 0.457 | −0.0022 |
| | 1 | 86.1 | 0.542 | −0.0242 |
| | 3 | 83.3 | 0.968 | −0.0545 |
| TPA-100 | 0.2 | 63.6 | 0.488 | −0.0208 |
| | 1 | 78.7 | 0.778 | −0.0470 |
| | 3 | 91.2 | 2.571 | −0.1439 |
| K-984 | 0.2 | 0.5 | 0.178 | −0.0079 |
| | 1 | 58.1 | 0.272 | −0.0086 |
| | 3 | 64.0 | 1.243 | −0.0558 |
| K-130 | 0.2 | 58.1 | 0.374 | −0.0243 |
| | 1 | 71.6 | 0.595 | −0.0403 |
| | 3 | 103.5 | 1.563 | −0.0706 |
| Not added | 0 | 1.3 | 0.177 | −0.0027 |

<Studies on Influence on Intrinsic Birefringence of Adhesive and Temperature Dependence in the Case where Kinds and Amounts of Raw Material Monomers for Copolymer Constituting Adhesive are Changed>

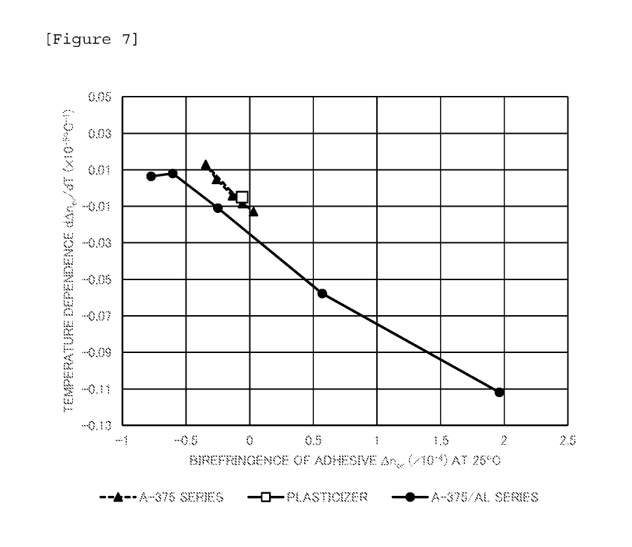

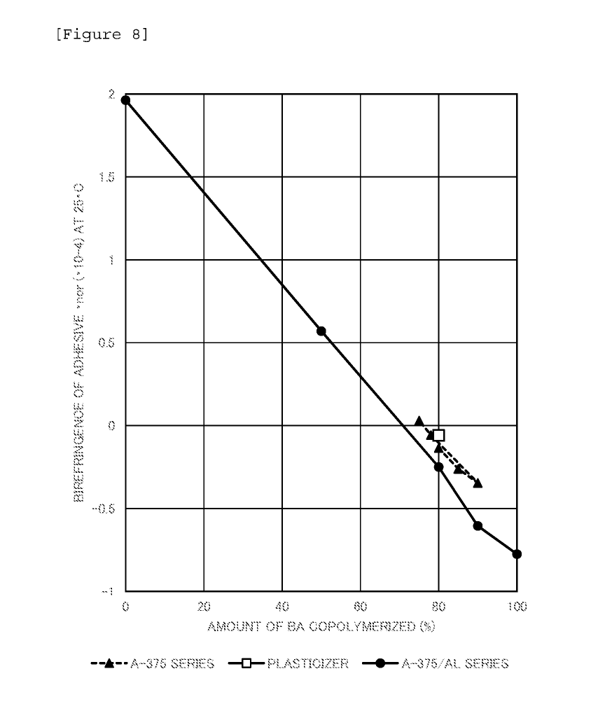

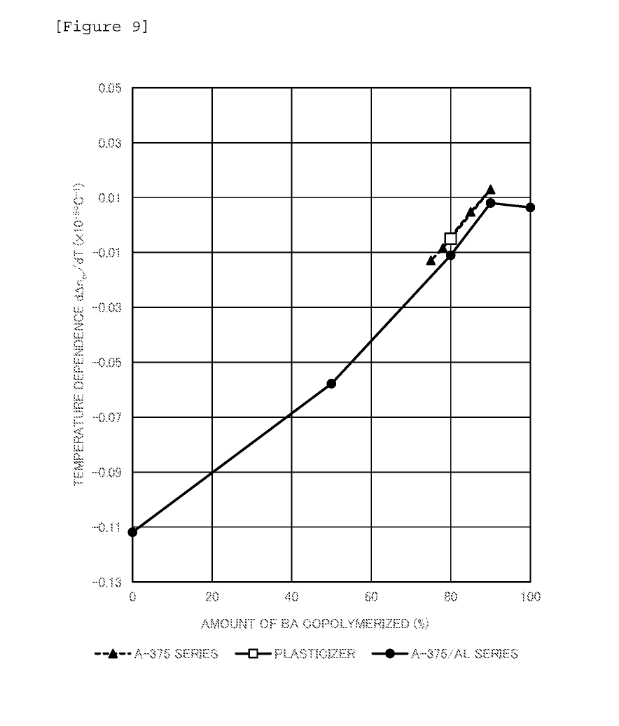

In the preparation of the adhesive described previously, monomers used in producing a polymer solution were used through selection from among butyl acrylate (BA), phenoxyethyl acrylate (PHEA), acrylic acid (AAc), and hydroxyethyl acrylate (HEC), and the ratios thereof in terms of mass parts were changed as shown in Table 4 to obtain polymer solutions each having a different composition in the manner as described previously. As shown in Table 4, adhesives of A375 series where 0.2% of the A375 was used as the hardener, adhesives of A375/AL series where 0.2% of the A375 was used together with the AL as the hardener, and an adhesive of A375 series where 0.2% of the A375 was used together with a plasticizer as the hardener were each prepared. The gel fraction of each adhesive obtained was measured, and it is shown in Table 4. The birefringence of an adhesive and the temperature dependence of the birefringence were determined for each adhesive obtained, and the obtained results are shown in Table 4. As a result, as shown in FIGS. 7 to 9, it was ascertained that A375/AL series have less influence on the birefringence as the crosslinking agent. In addition, a tendency was recognized that as the amount of butyl acrylate (BA) blended becomes large in preparing a polymer solution, the influence on the birefringence becomes large.

TABLE 4
Birefringence of adhesive and temperature dependence in the case where kinds and amounts
of monomers are changed

| | Composition ratio of | | | | Hardener | | | Gel | Δnₒᵣ × 10⁻⁴ | dΔnₒᵣ/dT × 10⁻⁵° C.⁻¹ |
|---|---|---|---|---|---|---|---|---|---|---|
| | copolymer | | | | Amount added (s/s) (%) | | | fraction | Intrinsic | Temperature |
| Series | BA | PHEA | AAc | HEA | A-375 | AL | Plasticizer | (%) | birefringence | dependence |
| A375 | 80 | 20 | 1 | | 0.2 | | | 89.1 | −0.136 | −0.0042 |
| Series | 85 | 15 | 1 | | 0.2 | | | 89.7 | −0.261 | 0.0048 |
| | 90 | 10 | 1 | | 0.2 | | | 87.9 | −0.346 | 0.0130 |
| | 78 | 22 | 1 | | 0.2 | | | 92.0 | −0.057 | −0.0084 |
| | 75 | 25 | 1 | | 0.2 | | | 91.1 | 0.03 | −0.0129 |
| | 80 | 20 | 1 | | 0.2 | | 5 | 84.1 | −0.059 | −0.0050 |
| A375/AL | 100 | 0 | 1.5 | 1 | 0.2 | 0.26 | | 90.6 | −0.775 | 0.0064 |
| Series | 90 | 10 | 1.5 | 1 | 0.2 | 0.26 | | 91.6 | −0.605 | 0.0080 |
| | 80 | 20 | 1.5 | 1 | 0.2 | 0.26 | | 88.3 | −0.250 | −0.0110 |
| | 50 | 50 | 1.5 | 1 | 0.2 | 0.26 | | 87.4 | 0.57 | −0.0578 |
| | 0 | 100 | 1.5 | 1 | 0.2 | 0.26 | | 88.6 | 1.962 | −0.1119 |

As shown in FIGS. 3,6, and 7 in which the relationship between the birefringence of an adhesive and the temperature dependence is shown as a graph, when the technique according to the present invention is utilized, an adhesive in which the intrinsic birefringence is almost zero and which is free of the temperature dependence of the birefringence can be obtained by suitably adjusting the kinds and amounts of monomers for forming a polymer solution constituting the adhesive and, further, the kind and amount of a crosslinking agent. More specifically, designing/producing an adhesive in which the temperature dependence of the birefringence is zero, the adhesive having an absolute value of the birefringence of an adhesive (|Δnₒᵣ<01) within a range of 0.2×10⁻⁴ or less, namely, within a range of ±0.2×10⁻⁴ and having an absolute value of the temperature dependence of the birefringence of an adhesive (|dΔnₒᵣ/dT|) of 0.02×10⁻⁵ or less, namely, within a range of ±0.02×10⁻⁵/° C. can be conducted.

Further, when the adhesive in which the temperature dependence of the birefringence is zero is used for liquid crystal displays and OLEDs, the birefringence of the adhesive does not occur even when the adhesive is deformed due to expansion and contraction of the optical film or the like, and therefore the liquid displays and OLEDs exhibit excellent optical performance without the light leakage and the like. Moreover, the birefringence of the adhesive is zero even when the temperature of the deformed adhesive is changed, and therefore the light leakage and the like do not occur.

1. A method for measuring temperature dependence of birefringence of an adhesive, the method comprising:
a step of preparing a laminated film in which polymer films are used as supports, and an adhesive comprising a (meth)acrylate-containing acrylic-based copolymer and a hardener added to the acrylic-based copolymer is given between two sheets of the supports to form an adhesive layer;
a step of hot-stretching the laminated film;
a step of measuring retardation of the laminated film after the hot-stretching; and
a step of measuring a thickness of the adhesive layer, wherein:
birefringence of an adhesive for the adhesive is defined as a value obtained by dividing the retardation by the thickness;
further, in the step of measuring the retardation, a temperature of the laminated film is controlled stepwise in a range of 15 to 70° C. to measure the retardation at each temperature, and from the obtained measurement results, a temperature coefficient of the birefringence of an adhesive dΔn⁰/dT is determined as an amount of change in the birefringence of an adhesive per 1° C. to quantify the temperature dependence of a birefringence value for the adhesive;
the polymer films to be used as the supports for the adhesive, when uniaxially stretched, each have an intrinsic birefringence within a range of ±0.05×10⁻⁴, and the polymer films each have a temperature coefficient of the intrinsic birefringence dΔn⁰/dT within a range of ±0.005×10⁻⁵ between 25° C. to 60° C., the temperature coefficient determined as an amount of change in the intrinsic birefringence per 1° C. from measurement results obtained in such a way that the uniaxially stretched film is used, a temperature of the film is controlled stepwise in a range of 25° C. to 60° C. to measure the intrinsic birefringence Δn⁰ at each temperature; and
a value of the birefringence of an adhesive at any temperature within a range of 15 to 70° C. for the adhesive to be used in quantifying the temperature dependence of the birefringence value for the adhesive is defined as a value obtained by dividing retardation measured with a birefringence measuring apparatus for a sample stretched to 2 times by the thickness of the adhesive layer, wherein the sample is prepared in such a way that the laminated film is cut into a dumbbell shape to make the sample, and the sample is mounted on a tensile testing machine with a thermostatic chamber, heated at a temperature of 102° C. for 120 seconds, thereafter stretched at a tension speed of 40 mm/min until a marked line becomes 2 times longer, then taken out after the stretching to be left to stand at room temperature for 24 hours, and thereafter further left to stand at any temperature within a range of 15 to 70° C. for 10 minutes.

2. A method for designing/producing an adhesive comprising a (meth)acrylate-containing acrylic copolymer and a hardener added to the (meth)acrylate-containing acrylic-based copolymer, the adhesive having a measured value of birefringence of an adhesive Δn⁰ within a range of ±0.2×10⁻⁴ and having a temperature coefficient of the birefringence of an adhesive dΔn⁰/dT within a range of ±0.02×10⁻⁵/° C., the birefringence of an adhesive and the temperature coefficient measured by a method for measuring the birefringence of an adhesive and a method for measuring the temperature dependence of the birefringence of an adhesive, wherein kinds and amounts of two or more monomer components for forming the (meth)acrylate-containing acrylic-based copolymer that constitutes the adhesive and a kind and an amount of the hardener that constitutes the adhesive are adjusted so that:
a value of the birefringence of an adhesive Δn⁰ at room temperature is within a range of ±0.2×10⁻⁴, the value obtained by dividing retardation measured with a birefringence measuring apparatus for a sample stretched to 2 times by a thickness of an adhesive layer, wherein the sample is prepared in such a way that a laminated film, in which polymer films each having an intrinsic birefringence within a range of ±0.05×10⁻⁴ and each having a temperature coefficient of the intrinsic birefringence within a range of ±0.005×10⁻⁵ are used as supports, and the adhesive obtained by adding the hardener to a solution of the (meth)acrylate-containing acrylic-based copolymer is given between two sheets of the supports to form the adhesive layer, is cut into a dumbbell shape to make the sample, and the sample is mounted on a tensile testing machine with a thermostatic chamber, heated at a temperature of 102° C. for 120 seconds, thereafter stretched at a tension speed of 40 mm/min until a marked line becomes 2 times longer, and then taken out after the stretching to be left to stand at room temperature for 24 hours; and
the temperature coefficient of the birefringence of an adhesive dΔn⁰/dT is within a range of ±0.02×10⁻⁵/° C., the temperature coefficient measured making use of the method for measuring the temperature dependence of the birefringence value, wherein a temperature of the laminated film is controlled stepwise in a range of 15 to 70° C. to measure the retardation at any temperature within the range separately, and from the obtained measurement results, a temperature coefficient of the birefringence of an adhesive dΔn⁰/dT is determined as an amount of change in the birefringence of an adhesive per 1° C. and measured by a method for measuring the temperature dependence of the birefringence, wherein the value of the birefringence of an adhesive at any temperature within the range, the value used in determining the temperature coefficient, is defined as a value obtained by dividing retardation measured with a birefringence measuring apparatus for a sample stretched to 2 times by a thickness of an adhesive layer, wherein the sample is prepared in such a way that the sample is mounted on a tensile testing machine with a thermostatic chamber, heated at a temperature of 102° C. for 120 seconds, thereafter stretched at a tension speed of 40 mm/min until a marked line becomes 2 times longer, then taken out after the stretching to be left to stand at room temperature for 24 hours, and thereafter further left to stand at any temperature within the range for 10 minutes.

3. An adhesive obtained by the method for designing/producing an adhesive according to claim 2, the adhesive comprising: a (meth)acrylate-containing acrylic-based copolymer; and a hardener added to the (meth)acrylate-containing acrylic-based copolymer, wherein
a measured value of birefringence of an adhesive Δn⁰ is within a range of ±0.2×10⁻⁴; and
a temperature coefficient of the birefringence of an adhesive dΔn⁰/dT is within a range of ±0.02×10⁻⁵/° C., the birefringence of an adhesive and the temperature coefficient measured by the method for measuring birefringence of an adhesive and the method for measuring temperature dependence of the birefringence of an adhesive.

4. A display comprising a structure obtained by pasting a transparent substrate and an optical film together through an adhesive layer, wherein the adhesive layer is formed with the adhesive according to claim 3.

5. An optical film with an adhesive, the optical film comprising an adhesive layer formed at least one surface thereof, wherein the adhesive layer is formed with the adhesive according to claim 3.
